(19) United States
(12) Patent Application Publication
(10) Pub. No.: US 2010/0138356 A1
(43) Pub. Date: Jun. 3, 2010

(54) SYSTEM AND METHOD FOR MANAGING AND VALUATING FINANCIAL INSTRUMENTS USING CUMULATIVE SUBPOSITIONS

(75) Inventors: Albrecht RICHTER, Ostringen (DE); Ulrich HAENLE, Wiesloch (DE); Madhusudan P, Bangalore (IN); Vikram KAMATH, Bangalore (IN)

Correspondence Address: KENYON & KENYON LLP, 1500 K STREET N.W., WASHINGTON, DC, 20005, US

(73) Assignee: SAP AG, Walldorf (DE)

(21) Appl. No.: 12/325,983

(22) Filed: Dec. 1, 2008

(51) Int. Cl. G06Q 40/00

(52) U.S. Cl. 705/36 R

(57) ABSTRACT

A system, method, and data structure for managing hedging relationships among stored transaction data. In an embodiment, the system opens a position associated with a valuation area, identifies a quantity of position assets to be hedged, and splits the position into a pair of subpositions, wherein the first subposition stores the quantity of position assets to be hedged and the second subposition stores a remaining quantity of position assets. In an embodiment, the system stores the subpositions, wherein it applies a first set of accounting rules to the first subposition and a second set of accounting rules to the second subposition.

### CROSS-REFERENCE TO RELATED APPLICATIONS

This application is related to U.S. patent application Ser. No. 12/199,775, filed Aug. 27, 2008, entitled “System and Method for Exposure Management.”

### COPYRIGHT AND LEGAL NOTICES

A portion of the disclosure of this patent document may contain material which is subject to copyright protection. The copyright owner has no objection to the facsimile reproduction by anyone of the patent document or the patent disclosure as it appears in the Patent and Trademark Office patent files or records, but otherwise reserves all copyrights whatsoever.

### BACKGROUND

Business entities, e.g., banks, enter into a large number of transactions in the ordinary course of their operations. Some of these transactions carry financial risks such as currency or foreign exchange (FX) risks, commodity price risks, interest rate risks, stock price risks, and counterparty risks, to name a few. For example, a securities instrument bears the risk of loss through a drop in prices. As another example, an increased or decreased value of the USD relative to the Euro affects foreign exchange (FX) risks in transactions involving those currencies.

To mitigate these risks, a business may invest in “hedging instruments” whose behavior counterbalances risks presented by financial transactions. Risk exposures presented by a first, typically numerically large, set of instruments are counterbalanced by performance of a second, typically much smaller, set of hedging instruments, such that when risk rises with respect to the instruments that present the risk exposures, risk falls in the hedging instruments. For example, a “forward security sale” is a special instrument that allows a business to sell a securities position to a counterparty in the future for a fixed price.

A set of instruments may be grouped and treated as a single exposure that is to be hedged; one or more hedging instruments counterbalance the exposure group. The exposures or exposure groups and their corresponding hedging instruments are grouped into corresponding hedging relationships. A hedging relationship associates one or more particular hedging instruments with a particular exposure or exposure group. Accordingly, use of hedging relationships aids in management of risk exposures and corresponding hedging instruments and facilitates compliance with hedging policies or regulations.

A company that invests in a hedging instrument to secure a risk of an existing investment (“hedge management”) may account for the profit and loss of both instruments so that they cancel each other out. This is called “hedge accounting” and is governed by generally accepted accounting principles such as Financial Accounting Statement (FAS) 133, Accounting for Derivative Instruments and Hedging Activities, promulgated by the Financial Accounting Standards Board (FASB), or International Financial Reporting Standard (IFRS) 39, Financial Instruments: Recognition and Measurement, promulgated by the International Accounting Standards Board (IASB), and/or the business's internal policies.

Different accounting rules like these may yield different profit or loss results given the same data. For example: suppose a business made two purchases:
Purchase 1: One share for $40 USD into security account 1
Purchase 2: One share for $70 USD into security account 2
Sale: One share for $100 USD from security account 1

Under Accounting Rule 1:

$$\begin{matrix}Profit = Sale price per share - Original purchase price per share \\ = \$100 USD - \$40 USD \\ = \$60 USD\end{matrix}$$

Under Accounting Rule 2:

$$\begin{matrix}Profit = Sale price per share - Average purchase price per share \\ = \$100 USD - ( \$40 USD + \$70 USD ) / 2 \\ = \$100 USD - \$55 USD \\ = \$45 USD\end{matrix}$$

Different accounting rules may apply to hedged assets versus non-hedged assets. Available computer applications aid in generating hedge accounting data and organizing and managing risk exposures, hedging instruments, and hedging relationships. At the top level, the Treasury Ledger (TRL) explains the position accounts of treasury products such as securities bonds, loans, and options. Within the TRL, Valuation Areas present different views of the same data to reflect how a treasury product or business transaction profit depends on the underlying account regulation (e.g., IFRS 39, FAS 133). Returning to the above example, then, a user might create two Valuation Areas within the TRL: one for Accounting Rule 1, and the other for Accounting Rule 2.

At the lowest level of existing applications, a Position is a group of stocks or financial positions that carries the values of the asset it represents. That is, the current value per date (“valuation”) is computed at the Position level according to rules stored in the position's management procedure. A position is the smallest unit in a TRL that may be valuated or managed independently; it is defined by fixed or variable terms that unambiguously identify that position. For example, Accounting Code, Valuation Area, Valuation Class, Product Type, and Security or Transaction ID might be fixed terms, so that any difference in these attributes definitely denotes separate positions. On the other hand, Security Account, Security Account Group, Portfolio, and Lot ID might be variable terms, so that their differentiating effect on positions may be set or customized by the user. Business transactions (such as purchases, sales, transfers, or dividend payments) under a given set of accounting rules are represented by Flows. The valuation of a position is based on the sums of flows related to that position.

FIG. 1 illustrates an example scenario using the prior art. Suppose on Jul. 1, 2008, XYZ Co. (or “XYZ”) purchases 10 units of STOCK_A at 40 EUR each into Security Account SEC_ACCT1. Suppose then that on Aug. 1, 2008, the XYZ purchases 10 more units of STOCK_A at 70 EUR each into Security Account SEC_ACCT2. The resulting flows are shown in FIG. 1a 101a-d, and the resulting position values are shown in FIG. 1b 102a-c. Since Valuation Area 001 groups by Security Account, and Flows 101a and 101b affect different security accounts, Flows 101a and 101b affect different Positions 102a-b in Valuation Area 001 (FIG. 1b 103a). Since Valuation Area 002 groups by Account Group, and Flows 101c and 101d affect the same account group, Flows 101a and 101b affect the same Position 102c in Valuation Area 002 (FIG. 1b 103b). Thus, three positions result:
Position 1 (102a): Valuation Area 001 SEC_ACCT1
Position 2 (102b): Valuation Area 001 SEC_ACCT2
Position 3 (102c): Valuation Area 002, GROUP1

Now suppose that, on Sep. 2, 2008, XYZ's accounting department executes a valuation with key date Aug. 31, 2008, to determine and disclose the value of the positions on that date. Suppose that the accounting rule for Valuation Area 001 requires taking the spot price, currently 80 EUR per share, of the security as the valuation basis. Suppose further that the accounting rule for Valuation Area 002 requires taking the closing price on August 31, which was 81 EUR per share, of the security as the valuation basis. The resulting position flows are shown in FIG. 1c:
Position 1 (102a) had a book value of 400 EUR.
New book value=10 units*80 EUR/unit=800 EUR
Write-up=400 EUR (shown as Flow 104a)
Position 2 (102b) had a book value of 700 EUR.
New book value=10 units*80 EUR/unit=800 EUR
Write-up=100 EUR (shown as Flow 104b)
Position 3 (102c) had a book value of 1100 EUR
New book value=20 units*81 EUR/unit=1620 EUR
Write-up=520 EUR (shown as Flow 104c)

The resulting position values are shown in FIG. 1d 102d-f.

Continuing the above example, suppose that on Sep. 15, 2008, XYZ sells the 10 units of STOCK_A in Security Account SEC_ACCT1 at 100 EUR each. This sale would trigger the creation of additional flows (derived flows) to adjust the position values and to account the profit or loss from the sale. That is, a profit/loss flow is created for each affected position. The resulting position flows are shown in FIG. 1e:
Position 1 (102d) had a book value of 800 EUR
It was sold completely for 1000 EUR (shown as flow 104d.1)
Gain=200 EUR (shown as flow 104d.2)
Position 2 (102e) was not affected by the sale, since the sale was made from SEC_ACCT1, not SEC_ACCT2.
Position 3 (102f) had a book value of 1620 EUR
Half of it (=book value of 810 EUR) was sold for 1000 EUR (shown as flow 104f.1)
Gain=190 EUR (shown as flow 104f.2)

The resulting position values are shown in FIG. 1f 102g-i.

But suppose, for example, that XYZ now hedged 8 of the 10 stocks in SEC_ACCT2. As noted above, different accounting rules may apply to some or all of a position depending on, for example, which stocks within the position are hedged. In this example, then, future business transactions may have different effects on the 8 hedged stocks than on the 2 non-hedged (freestanding) stocks, even though all 10 stocks are in the same position. However, existing applications do not differentiate between hedged and non-hedged assets when applying accounting rules.

Thus, a system is needed to manage and valuate the hedged portions of a financial position separately from the freestanding portion if only part of a position is hedged. For accurate accounting, financial instruments may not be moved to a separate account if hedged or used as a hedging instrument. Moreover, the combined value of the hedged and freestanding portions of a position must equal the total value of the position. Also, the user must be able to view the hedged and freestanding parts of a position value both as one value and as separate values. Finally, to facilitate compatibility with existing systems and business processes, the treatment of financial positions as positions in the system must not change.

### SUMMARY OF INVENTION

Embodiments of the present invention enable users to direct different accounting rules to hedged assets than to freestanding assets by creating a new entity called a “subposition” that identifies a portion of a position. Subpositions are cumulative in that the sum of the values of a subposition component equal the value of the corresponding position component. Thus, hedged and freestanding portions may be independently managed and valuated while allowing operative actions (e.g., sales, purchases, valuations) to continue to run on a position level.

### BRIEF DESCRIPTION OF THE DRAWINGS

FIG. 1 illustrates an example scenario, according to the prior art.

FIG. 2 illustrates an example system and method, according to an embodiment of the present invention.

FIG. 3 illustrates an example scenario, according to an embodiment of the present invention.

### DETAILED DESCRIPTION

Embodiments of the present invention relate to a solution for managing and valuating financial instruments using cumulative subpositions. Embodiments of the present invention direct different accounting rules to hedged and freestanding assets, as applicable, while maintaining the cumulative values of each corresponding position component. Thus, subpositions may be independently managed and valuated without affecting the treatment of financial positions as positions. Example embodiments of the present invention further allow the user to view the hedged and freestanding parts of a position value both as one value and as separate subposition values.

In example embodiments, each subposition holds the master data that identifies a portion of the position. For example, a subposition may identify a portion of a position as relating to a hedging instrument, a hedged item, or a freestanding item, and it may hold all hedging-related information about that portion of a position.

In example embodiments, subpositions are associated with certain value components, such as the number of units, consolidated security gains or losses, consolidated FX gains or losses, hedge adjustment, fair value hedge, and cash flow hedge. In example embodiments, the subpositions are “cumulative”: that is, the sum of the component values of the subpositions within a position equals the component value of that position. For example, if Position 1 contains Subposition A and Subposition B, then the number of units in Subposition A plus the number of units in Subposition B equals the number of units in Position 1. Since subpositions are cumulative, valuation areas and positions remain unaffected. In an embodiment, the TRL provides links to the subpositions.

In example embodiments, each flow maps through one position to one subposition; subpositions do not overlap, and each flow is assigned to a single subposition. If a flow is not assigned to any subposition, then it is assumed to affect the freestanding subposition. Each flow holds information concerning the subposition to which it is assigned.

For purposes of illustration, the below example embodiments of the present invention largely concern stock price risk. However, the embodiments may be used for other purposes as would be evident to one of skill in the art. For example, embodiments of the present invention may manage or simulate all kinds of risks, such as financial risks including foreign exchange risk, interest rate risk, commodity price risk, stock price risk and counterparty risk.

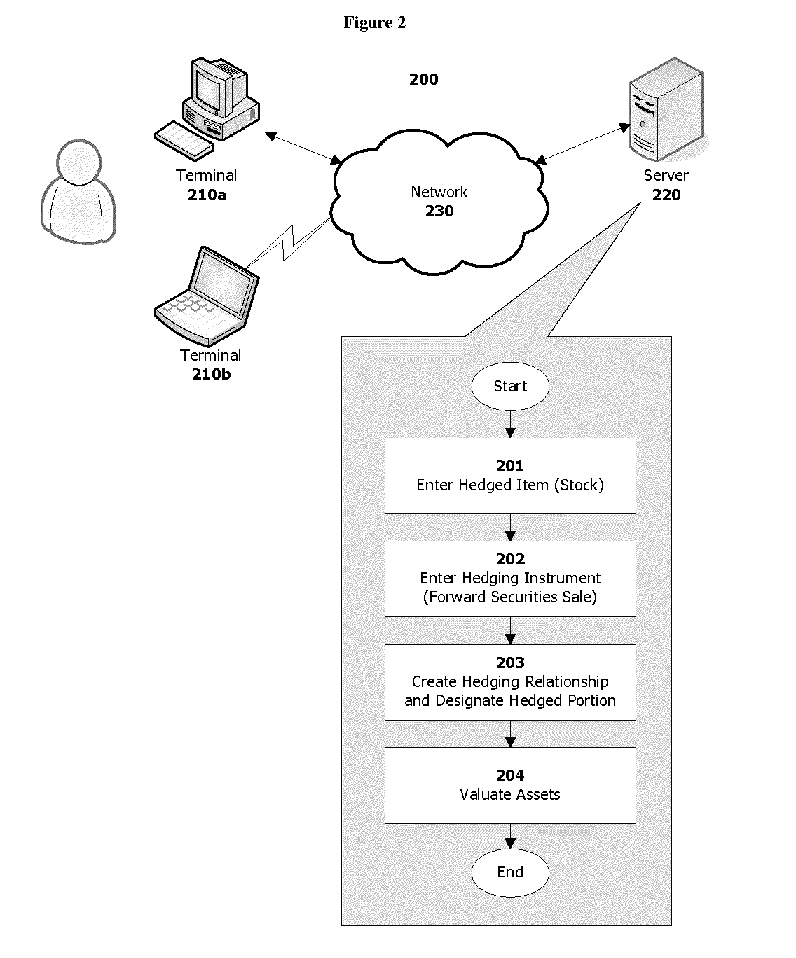

FIG. 2 is a simplified block diagram of a system 200 according to an embodiment of the present invention. As shown, the system 200 may include one or more computer terminals 210 coupled to one or more servers 220 via a network 230. The terminals 210 provide user interface points at which users may interact with the system to enter, view, and manage financial data. The financial data will typically be calculated and maintained by applications executing on the servers 220 although, in some instances, such applications will execute on the terminals 210. The network 230 provides a communication medium between the terminals 210 and the servers 220, which may exchange communication between network components according to wired and/or wireless protocols. A variety of network topologies are well known for such computer systems 200; the number of terminals 210, the number of servers 220, and differences in network topologies are immaterial to the present invention unless otherwise mentioned.

The system may be programmed to manage and valuate hedged, hedging, and freestanding assets according to relevant accounting rules, for example as summarized in steps 201-204.

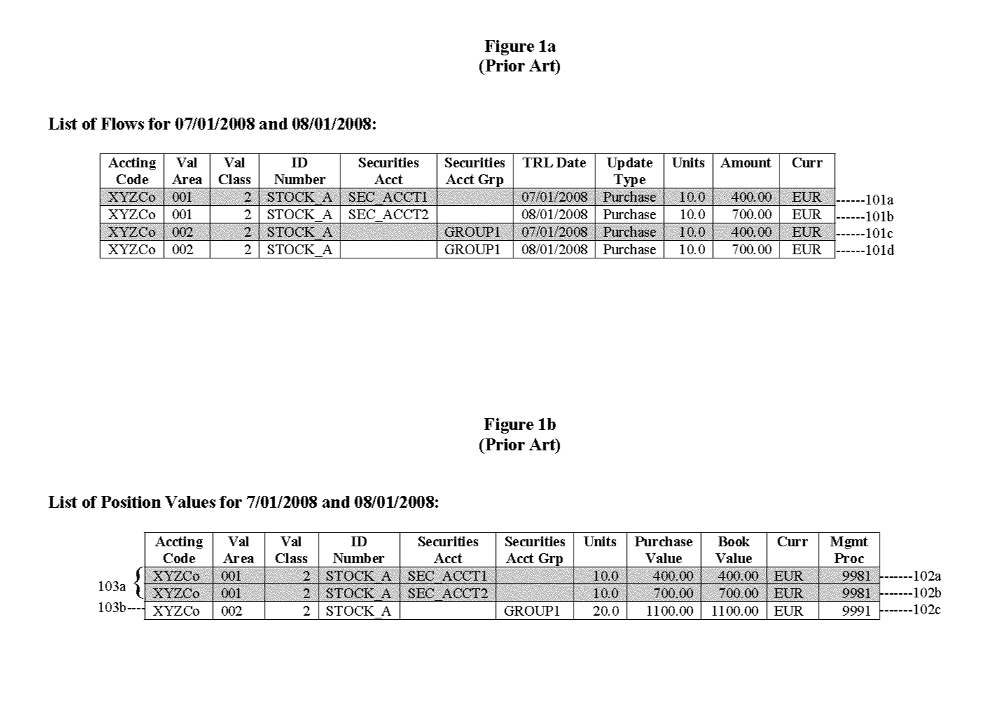

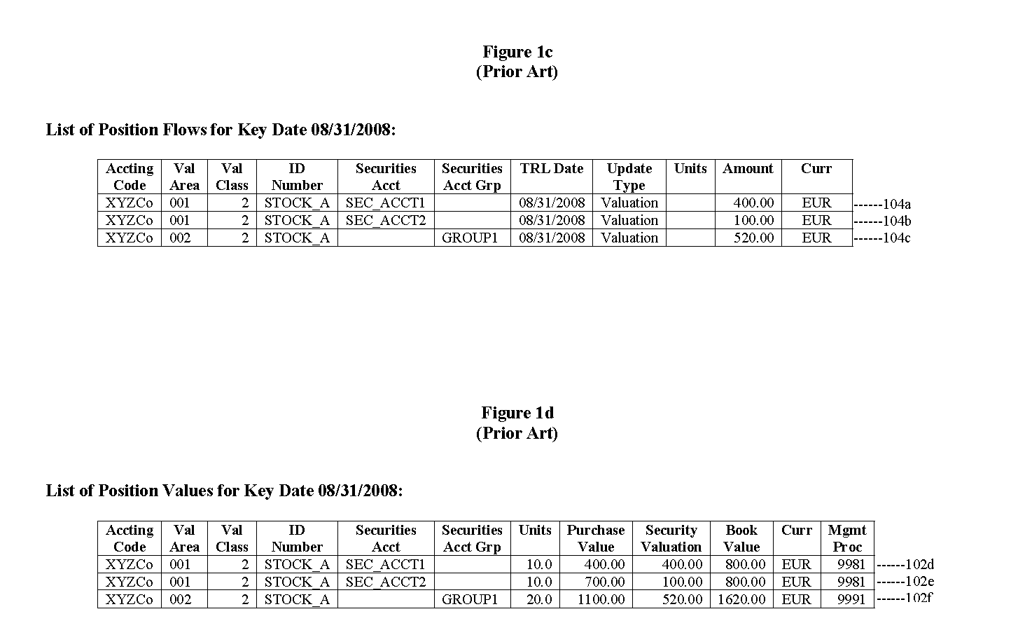

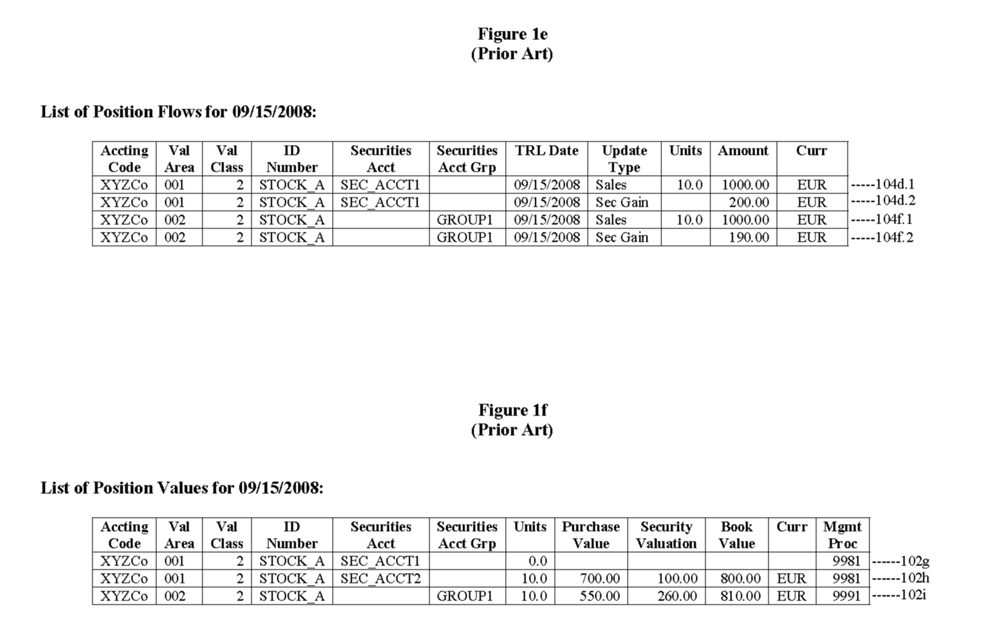

In step 201, the user enters a hedged item (such as stock) purchase in the system, for example as described above and shown in FIG. 1.

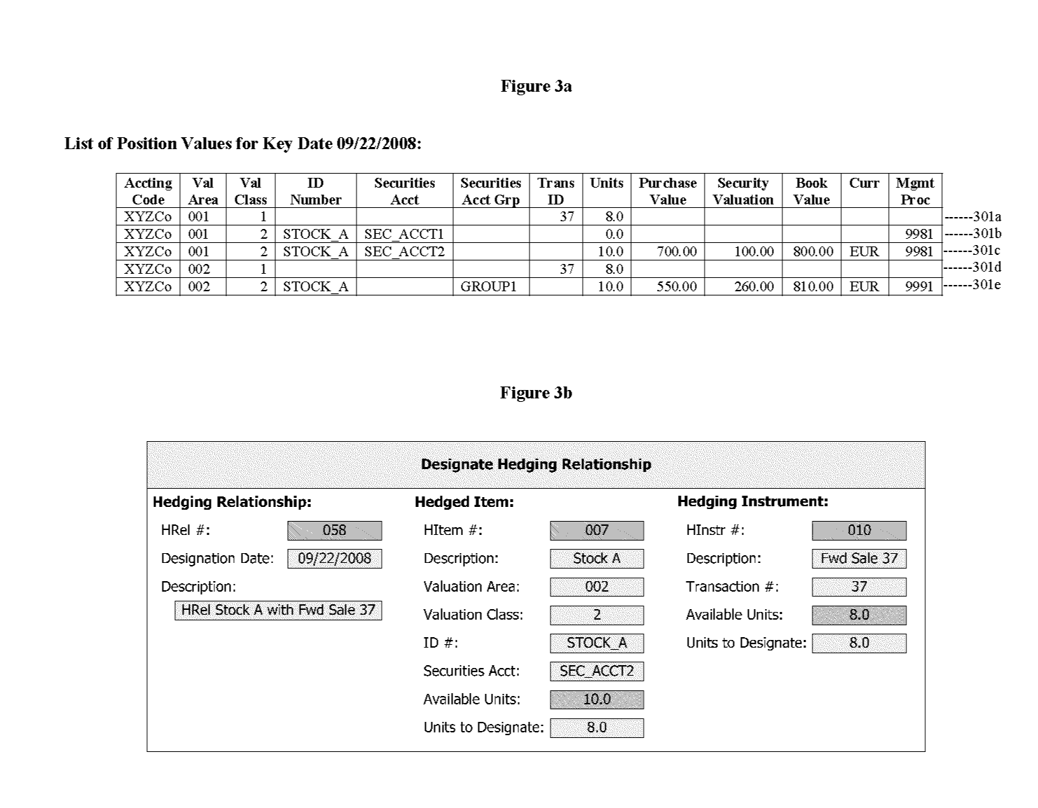

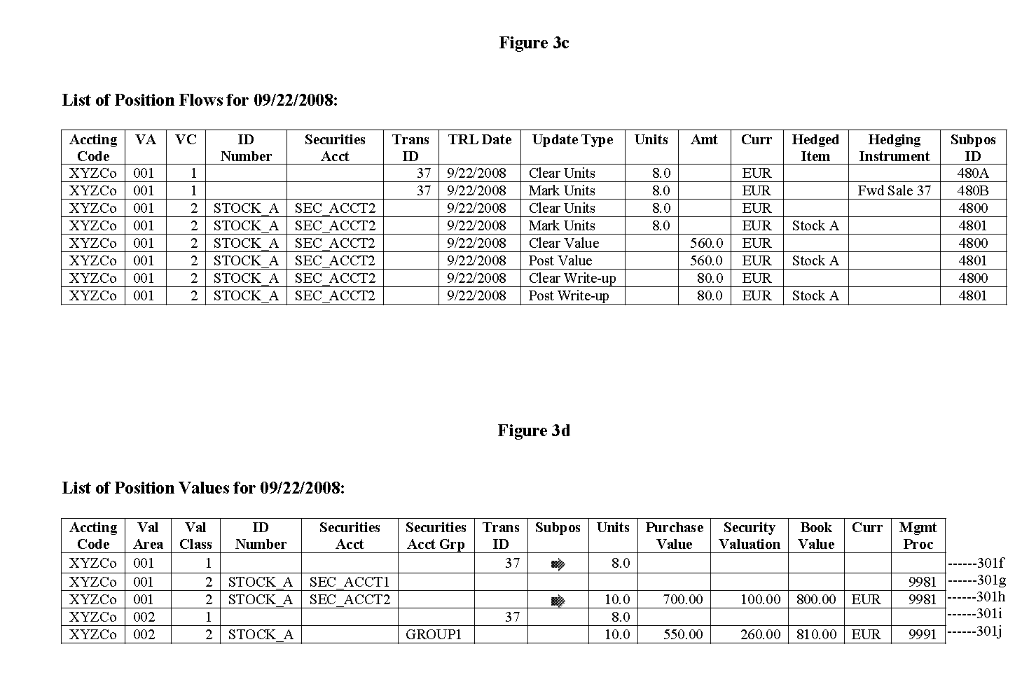

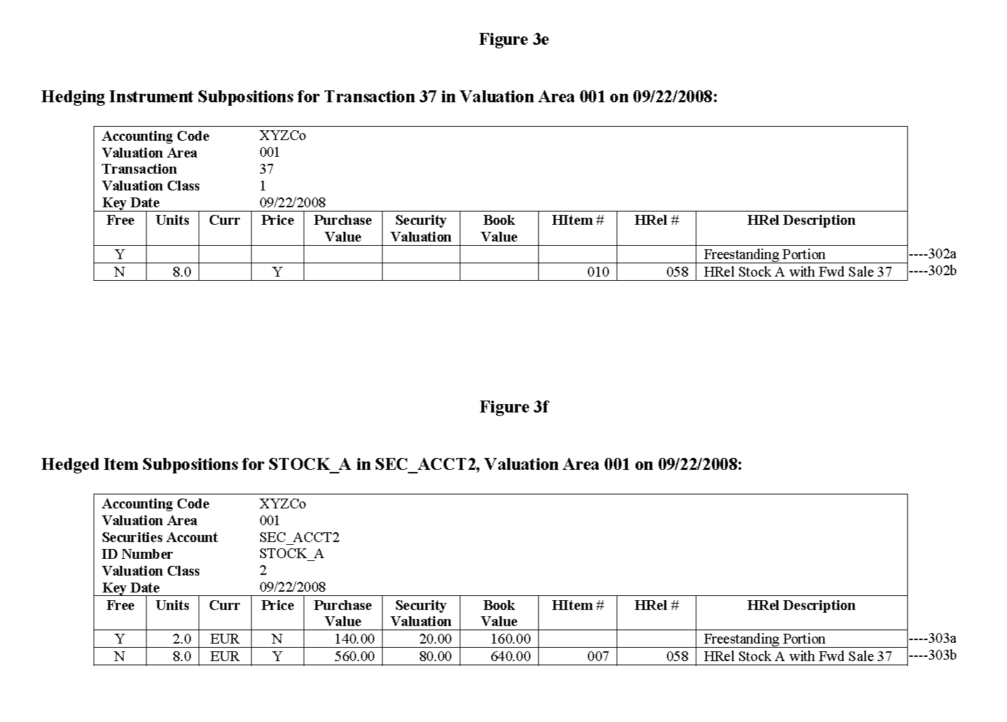

In step 202, the user enters a hedging instrument (such as a forward securities sale) purchase in the system. Continuing the example above, suppose that on Sep. 22, 2008, to hedge part of Position 2, XYZ concludes Transaction #37, a forward securities sale which allows it to sell 8 units of STOCK_A at 90 EUR each on Dec. 22, 2008. The forward securities sale appears as one position per valuation area in the position list, as shown in FIG. 3a 301a and 301d.

In step 203, the user creates a hedging relationship in the system between the hedged item (for example, the stock position) and the hedging instrument (for example, the forward securities sale). The user may designate some or all of the hedged item as hedged, leaving the remainder freestanding.

FIG. 3b illustrates step 203 with respect to the above example. Since transaction #37 allows XYZ to hedge 8 units of STOCK_A in SEC_ACCT2 (Position 2), XYZ would a create hedging relationship in Valuation Area 001 with Transaction #37 as the hedging instrument and STOCK_A in SEC_ACCT2 as the hedged item. XYZ would then designate 8 of the 10 units in Position 2 as related to hedging instrument Transaction #37. In an embodiment, the hedging relationship ID (HRel #), hedged item ID (HItem #), hedged instrument ID (HInstr #), and Available Units fields may be auto-populated based on, for example, other information entered into the form.

In example embodiments, designating hedged units triggers the creation of separate subpositions to maintain the freestanding and hedged parts of the hedging instrument and hedged item:
Non-hedging part of hedging instrument Fwd Sale 37: Subposition 480A
Hedging part of hedging instrument Fwd Sale 37: Subposition 480B
Freestanding part of hedged item Stock A: Subposition 4800
Hedged part of hedged item Stock A: Subposition 4801

These subpositions are shown in FIG. 3c; FIG. 3c also shows the resulting flows (“derivative flows”) that transfer units and proportionate values from the freestanding subpositions to the hedged subpositions:
Decrease units in Subposition 480A (non-hedging Fwd Sale 37) by 8
Increase units in Subposition 480B (hedging Fwd Sale 37) by 8
Decrease units in Subposition 4800 (freestanding Stock A) by 8
Increase units in Subposition 4801 (hedged Stock A) by 8
Decrease purchase value of Subposition 4800 (freestanding Stock A) by 8 units*70 EUR/unit purchase price=560 EUR
Increase purchase value of Subposition 4801 (hedged Stock A) by 8 units*70 EUR/unit purchase price=560 EUR
Decrease Security Write-Up of Subposition 4800 (freestanding Stock A) by 8 units*(80 EUR/unit book val−70 EUR/unit purch price)=80 EUR
Increase Security Write-Up of Subposition 4801 (hedged Stock A) by 8 units*(80 EUR/unit book val−70 EUR/unit purch price)=80 EUR

FIG. 3d shows the resulting position values. As is evident by comparing FIG. 3d to FIG. 1f and FIG. 3a, the positions within a hedging instrument or hedged item and their values remain unchanged. In example embodiments, no subposition is created within any freestanding position (that is, any position for which no hedging relationship is defined, such as SEC_ACCT1 in Valuation Area 001 or Transaction 37 and GROUP1 in Valuation Area 002). In this example, the freestanding subposition now includes 2/10 of the position values, and the hedged subposition includes 8/10. However, a subposition may include different kinds of position component values if, for example, different accounting rules apply to hedged versus freestanding subpositions. Nevertheless, in any case, the sum of each subposition value equals the corresponding position value.

In an example embodiment, an additional button in the position list links to a subposition display for a position. FIG. 3e shows such a subposition display for the position shown as FIG. 3d 301f (i.e., the hedging instrument Transaction 37 in Valuation Area 001). In example embodiments, as mentioned above, the subposition comprises the position information regarding the hedge relationship. In this example, note that there are no position component values for Transaction 37 in Valuation Area 001, since the net present value of the forward sale was set to 0 at designation.

FIG. 3f shows the corresponding subposition display for the position shown as FIG. 3d 301h (i.e., the hedged item in Position 2, Valuation Area 001, SEC_ACCT2). Again, the subposition comprises the position information regarding the hedge relationship.

Note that the hedging relationships created in Valuation Area 001 do not affect the positions in Valuation Area 002, since the positions in Valuation Area 002 do not coincide with the hedged positions in all relevant differentiation criteria. (In this case, for example, Valuation Area 002 does not differentiate by securities account.) This allows the valuation areas to continue to operate under entirely separate accounting rules.

In step 204, the system valuates all hedged, hedging, and freestanding assets (for example, at the end of an accounting period such as a fiscal quarter), each according to the appropriate accounting rules.

From the foregoing description, those skilled in the art can appreciate that the present invention may be implemented in a variety of forms. For example, the above embodiments may be used in various combinations with and without each other. Therefore, while the embodiments of the present invention have been described in connection with particular examples thereof, the above embodiments are for illustration purposes only and are not meant to limit the scope of the present invention. Other modifications will become apparent to the skilled practitioner upon a study of the present application.

What is claimed is:

1. In a computer system, a method for managing hedging relationships among transaction data stored by the computer system, the method comprising:
responsive to user input, opening a position associated with a valuation area, the position identifying an aggregation of the transaction data that matches a set of selection criteria;
identifying, from user input, a quantity of position assets to be hedged by a hedging portion of a hedging instrument according to a hedging relationship;
splitting the position into a pair of subpositions, each subposition storing data of the position, wherein a first subposition stores the quantity of position assets to be hedged and the second subposition stores a remaining quantity of position assets; and
storing the subpositions in the computer system, wherein
the computer system applies a first set of accounting rules to the first subposition according to accounting rules of the hedging relationship, and
the computer system applies a second set of accounting rules to the second subposition according to accounting rules free from the hedging relationship.

2. The method according to claim 1, wherein the transaction data relates to securities.

3. The method according to claim 1, wherein the transaction data relates to bonds.

4. The method according to claim 1, wherein the transaction data relates to loans.

5. The method according to claim 1, wherein the transaction data relates to options.

6. The method according to claim 1, wherein the position is associated with a consolidated security gain or loss.

7. The method according to claim 1, wherein the position is associated with a consolidated foreign exchange gain or loss.

8. The method according to claim 1, wherein the position is associated with a hedge adjustment.

9. The method according to claim 1, wherein the position is associated with a fair value hedge.

10. The method according to claim 1, wherein the position is associated with a cash flow hedge.

11. The method according to claim 1, wherein the set of selection criteria comprises the valuation area.

12. The method according to claim 1, wherein the set of selection criteria comprises a securities account.

13. The method according to claim 1, wherein the set of selection criteria comprises a securities account group.

14. The method according to claim 1, wherein the set of selection criteria comprises an accounting code.

15. The method according to claim 1, wherein the set of selection criteria comprises a valuation class.

16. The method according to claim 1, wherein the set of selection criteria comprises a product type.

17. The method according to claim 1, wherein the set of selection criteria comprises a security identification number.

18. The method according to claim 1, wherein the set of selection criteria comprises a transaction identification number.

19. The method according to claim 1, wherein the set of selection criteria comprises a portfolio.

20. The method according to claim 1, wherein the set of selection criteria comprises a lot identification number.

21. The method according to claim 1, wherein the valuation area is associated with an account regulation comprising the first and second accounting rules.

22. The method according to claim 1, wherein the valuation area identifies a second aggregation of the transaction data that matches a second set of selection criteria;

23. The method according to claim 22, wherein the second set of selection criteria comprises a securities account.

24. The method according to claim 22, wherein the second set of selection criteria comprises a securities account group.

25. The method according to claim 1, wherein the hedging instrument comprises a forward securities sale.

26. The method according to claim 1, further comprising displaying the first subposition.

27. The method according to claim 1, further comprising displaying the second subposition.

28. The method according to claim 1, further comprising displaying the position.

29. The method according to claim 28, further comprising displaying a link which, when activated, displays the first subposition and the second subposition.

30. The method according to claim 1, further comprising:
splitting the hedging instrument into a second pair of subpositions, each subposition storing data of the hedging instrument, wherein a third subposition stores the hedging portion of the hedging instrument and the fourth subposition stores a remaining quantity of hedging instrument assets; and
storing the second pair of subpositions in the computer system, wherein
the computer system applies a third set of accounting rules to the third subposition according to accounting rules of the hedging relationship, and
the computer system applies a fourth set of accounting rules to the fourth subposition according to accounting rules free from the hedging relationship.

31. The method according to claim 30, wherein the valuation area is associated with an account regulation comprising the third and fourth sets of accounting rules.

32. The method according to claim 30, further comprising displaying the third subposition.

33. The method according to claim 30, further comprising displaying the fourth subposition.

34. The method according to claim 30, further comprising displaying the hedging instrument.

35. The method according to claim 34, further comprising displaying a link which, when clicked, displays the third subposition and the fourth subposition.

36. A system for managing hedging relationships among transaction data stored by the system, comprising:
a display;
a processor; and
a computer-readable storage medium storing:
a first data object corresponding to a position associated with a valuation area, the position identifying an aggregation of the transaction data that matches a set of selection criteria,
a pair of second data objects, each second data object corresponding to a subposition storing data of the position, wherein a first subposition stores a quantity of position assets to be hedged by a hedging portion of a hedging instrument according to a hedging relationship and the second subposition stores a remaining quantity of position assets, and
instructions to be executed by the processor, which instructions, when executed, perform a method comprising:
responsive to user input, opening the position,
identifying, from user input, the quantity of position assets to be hedged,
splitting the position into the first and second subpositions, and
storing the subpositions in the system, wherein
the system applies a first set of accounting rules to the first subposition according to accounting rules of the hedging relationship, and
the computer system applies a second set of accounting rules to the second subposition according to accounting rules free from the hedging relationship.

37. A data structure stored in a computer system memory, the structure associated with managing hedging relationships among transaction data stored by the computer system, the structure comprising:
data corresponding to a position associated with a valuation area, the position identifying an aggregation of the transaction data that matches a set of selection criteria;
data corresponding to a first subposition storing data of the position, wherein the first subposition represents a quantity of position assets to be hedged by a hedging portion of a hedging instrument according to a hedging relationship; and
data corresponding to a second subposition storing data of the position, wherein the second subposition represents a remaining quantity of position assets,
wherein the data structure enables a processor to perform a method comprising:
responsive to user input, opening the position,
identifying, from user input, the quantity of position assets to be hedged,
splitting the position into the first and second subpositions, and
storing the subpositions in the computer system, wherein
the computer system applies a first set of accounting rules to the first subposition according to accounting rules of the hedging relationship, and
the computer system applies a second set of accounting rules to the second subposition according to accounting rules free from the hedging relationship.
